(19) United States
(12) Patent Application Publication
(10) Pub. No.: US 2002/0122882 A1
(43) Pub. Date: Sep. 5, 2002

(54) Compositions and method of coating automotive underbodies

(76) Inventors: Patrick Benson, West Sussex (GB); Timothy Clayfield, Commugny (CH)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/049,413

(22) PCT Filed: Jun. 5, 2001
(86) PCT No.: PCT/IB01/00978

(30) Foreign Application Priority Data
Jun. 10, 2000 (GB) 0014087.1

(51) Int. Cl. B05D 3/02; B05D 1/04; B05D 1/06

(52) U.S. Cl. 427/195; 427/475; 427/318; 427/385.5; 427/421

(57) ABSTRACT

A method of coating some or all of an underbody of a vehicle on a production line, comprising applying a polymeric coating powder to the underbody or the vehicle body part, sintering the powder to the underbody or the vehicle body part. The polymeric coating powder includes a mixture comprising a polyolefin having polar functionality, and one or more ethylene α-olefln copolymers, the mixture having a melt flow index greater than 15 g/10 minutes (2.16 kg, 190° C.). The polymeric coating powder preferably has a melt flow index greater than 20 g/10 minutes. The ethylene α-olefln copolymer should contain at least 50 mole % ethylene. The α-olefin co-monomer may be chosen from propylene, butene, hexene or octene. The polymer having polar functionality may be a copolymer of ethylene with at least one polar monomer.

This invention relates to coating parts of car bodies, in particular the car underbody.

The underbody of a car is frequently subjected to water from the road surface, depending on the climate were the car is driven. In climates which experience freezing temperatures, common salt mixed with grit is often laid on the road, to melt ice and provide traction. The hard and abrasive particles of grit or similar matter, together with water, especially salty water, make for a very harsh environment.

A known way of protecting the underbody of a car from abrasion and subsequent corrosion is to spray it with a coating of a polyvinyl chloride (PVC) plastisol. The PVC is mixed with plasticisers and solvents so that it may be sprayed. Once applied to the underbody of the car, the solvent evaporates in a baking oven, leaving the PVC to set.

The volatile solvents and plasticisers used, such as phthalate compounds, have been implicated as damaging to health and the environment, these solvents and plasticisers being released not only during application but through their life. When the car is disposed, the PVC remaining in the shredder waste may be burnt, this action may release dioxins, hydrogen chloride, and other chlorinated chemicals.

Current industrial application methods used to apply PVC plastisols to underbodies often leads to over-spray of the PVC onto the vertical body panels. In such cases, removal of the PVC over-spray necessitates the use of solvents and manual labour. Additionally, some PVC plastisol spray misses the vehicle shell entirely; such over-spray is non-recyclable, leading to material wastage, and the overspray creates a hazardous working environment to workers who manually apply such underbody coating materials.

Plastisols of polymers other than PVC, such as styrene block copolymers are also known, with the advantage that they contain little or no chlorine, but with the disadvantage of containing plasticisers. Recently, efforts have been made to develop underbody coatings from epoxy and polyurethane powders, using very low molecular weight precursors that chemically crosslink after application, to give a tough coating. These materials are reactive and can be toxic and hazardous if precautions are not taken.

The PVC-plastisol mixture can be conveniently applied to automobiles on a production line process, where PVC is sprayed onto each car as one of the processes in the production line sequence. The PVC is heated at around 150° to 180° C. for around 15-20 minutes.

WO 009618 (Henkel) discloses thermoplastics having a melting range of 50° to 180° C. having polar groups, and suggests using the main binder from lacquer systems, but without the presence of, or with only very small amounts of crosslinkers. Particular suggested powder lacquer binders include those based on polyurethane having a melting range of between 80° and 100° C. with a melt flow index (MFI) of 30 and 40 g/10 minutes, polyethylene-acrylate copolymer powders having a (MFI) between 5 and 15 g/10 minutes, thermoplastic polyurethanes, polyamide powders having a (MFI) between 15 and 40 g/10 minutes, ethylene vinyl acetate copolymer powders and pretreated LDPE (low density polyethylene).

Underbody sealants are required to remain tough and flexible at temperatures as low as −40° C., and they must adhere to the material making up the underbody, including the anodic and cathodic protection on the car body. Ideally, the sealants should allow a coating of paint to be applied upon them.

It is the object of the present invention to provide a coating and method of application for the underbody of a vehicle as part of a production line process which will alleviate the problems associated with PVC and other prior art coatings.

According to the present invention there is provided a method of coating a least part of an underbody of a vehicle on a production line, comprising applying a polymeric coating powder to the underbody or the vehicle body part, and sintering the powder to the underbody or the vehicle body part, the polymeric coating powder including a mixture comprising a polyolefin having polar functionality, and one or more ethylene α-olefin copolymers, the mixture having a melt flow index greater than 15 g/10 minutes (2.16 kg, 190° C.).

Preferably the polymeric coating powder has a melt flow index greater than 20 g/10 minutes. Preferably the ethylene α-olefin copolymer contains at least 50 mole % ethylene. The α-olefin co-monomer may be chosen from the group containing propylene, butene, hexene or octene. Preferably the polymer having polar functionality is a copolymer of ethylene with at least one polar monomer.

The polar monomer may be acrylic acid, methacrylic acid, butyl acrylate, ethyl acrylate, methyl acrylate or vinyl acetate. The polar copolymers may be taken from the groups containing copolymers or terpolymers of ethylene or other alpha olefins with acrylic acid, methacrylic acid, butyl acrylate, ethylene acrylate, methylene acrylate, vinyl acetate, vinyl styrene, or other alkyl acrylates or methacrylates, or alkyl carboxylic acids. One or more of the polymers having polar functionality may be a grafted polyolefin.

According to further aspects of the present invention there are provided a vehicle underbody as herein defined.

As part of a production line process, it is desirable to keep the temperature of the oven in which the coating is applied and cured to below 160°, since by moving of cars through ovens in a production line manner means increasing high energy losses for ovens having temperatures much above this. Also, it is desirable to minimise the length of curing time, which should not be above 20 minutes (15-20 minutes is considered an acceptable range), since a process taking any longer holds up the production line, and increases the amount of time the oven has to be heated.

The use of bindings as suggested in the Henkel application require a greater temperature to be applied in the oven, or a longer time in which to be ‘stoved’ (that is, cured). If either of these factors is reduced, there is a risk of reduced wetting of the interface between the coating and the substrate, or the formation of pinholes or a rough finish.

In order to reduce the length of time and temperature that the coating powder must be subjected to in order to properly fuse into a pinhole free coating and for the coating to wet properly onto the surface of the substrate for adequate long term adhesion, the MFI is chosen to be greater than 15 g/10 minutes. Increasing MFIs in polyolefin based coatings generally causes the mechanical properties to be adversely affected, including a decrease in the abrasion resistance.

It has been found that using a polyolefin having polar functionality and one or more ethylene α-olefin copolymers to produce a coating powder, this coating powder having a melt flow of more than 15 g/10 minutes, gives a coating composition that can be satisfactorily applied and cured at temperatures below 160° C. and within time periods of 15-20 minutes, and has good mechanical properties, including good adhesion to substrates and good abrasion resistance. Polar functionalised polyolefin and ethylene α-olefin copolymer mixes having MFIs of less than 15 g/10 minutes, if they are to flow sufficiently to wet the surface for good long term adhesion, must be fired at higher temperatures and/or for longer periods. The resulting coating from mixes having MFIs of less than 15 g/10 minutes have a rough and/or wavy appearance, and an increased risk of pinholes.

Ideally, the composition will have an melt flow index of more than 20 g/10 minutes. This results in a smooth finish to the surface. It has been found that smooth finishes appear to give better abrasion resistance than rough surfaces, are more aesthetically pleasing. A smooth surface also provides a greater minimum thickness for the same amount of coating material than a relatively rough surface.

The invention will now be described, by way of example.

A blend of polyolefins is heated above its melting point in an extruder or other mixing device, and blended with stabilisers, fillers, pigments, fire retardants, and like additives.

Due to the polar nature of typical electrocoats and other underbody surfaces, the blend contains some element with polar functionality to ensure adhesion to the substrate; such element includes a component with innate polarity, such as a copolymer of ethylene with a polar monomer or a polymer grafted with polar functionality. if the blend contains no component with innate polarity prior to blending, this polarity may be introduced into the composition by a grafting operation in the extruder. The resulting polyolefins, which include for example silane- or anhydride-grafted polyolefins, copolymers of ethylene and higher α-olefin with acrylic acid, ethyl acrylate, vinyl acetate, vinyl styrene, or ionomers, are more adhesive than a non-polar polyolefin. Polymers such as ethylene-styrene interpolymers may be included in the blend to contribute their damping qualities. Other polymers having desirable toughness, stiffness, adhesiveness, melting points or other desirable characteristics may similarly be included in the blend.

This blend is then converted into a powder by grinding, micropellitisation, spinning or water dispersal processes. If the conversion to powder performed by a grinding process, it may be carried out at ambient temperatures, or the polyolefin may be cooled to aid the process. The particle size of the powder is typically 94% below 150 microns This powder may be mixed with anti-caking and anti-static agents; such agents are typically inorganic components, such inorganic components of the blend being added in powder form at this stage. Alternatively, the inorganic components of the blend could be mixed whilst the polyolefin is molten.

The powder particles are given an electric charge. The vehicle underbody to be coated is first phosphated or chromated, and ‘e-coated’ (i.e. by cataphoresis or electro-dipcoating) and washed and dried. The powder may be charged so that as it is expelled from a spray gun onto the underbody, it remains on the underbody by electrostatic attraction. The coating is then heated at a temperature below 160° C. for a period of not more than 20 minutes, typically in the range of 15 to 20 minutes. The automobile may be heated in other stages, such as after the application of external paint.

Additionally or alternatively, the underbody may be heated so that powder alighting upon the underbody becomes viscous and adheres to the underbody.

Several spray guns are employed to coat the underbody. Different spray guns are adapted to apply different thicknesses or widths of the polyolefin powder to different parts of the underbody as required.

Excess powder is removed using a vacuum cleaner. If the coating is sufficiently accurately applied, it may not be necessary to remove any powder.

The underbody is then transferred to an oven, where it is heated at a temperature of 150-160° C. for a period of about 15-20 minutes, which is a sufficient temperature for a sufficient length of time to melt the powder and cause it to fuse into a coherent film and adhere to the substrate.

In addition, the blend could be used as a hot-melt sealant for underbody seams. If the powder is to be applied along a seam, the heating may be confined to the regions along the seam edge.

The coating may be further treated in order to cross-link the polyolefin, for example using UV radiation, electron beams, gamma rays, together with initiators or catalysts if necessary. The polyolefin blend could include appropriate curing agents, such as epoxies for anhydride-grafted, ionomeric or other acid-functional polymers, or, if the resin was silane-grafted, by using moisture or another agent. The polyolefin could be produced using a single site constrained geometry catalyst, a metallocene-type catalyst, or by the more conventional Ziegler-Natta catalyst types.

After cooling, the underbody may be painted or further coated if required, or taken directly to be assembled into the vehicle.

Since the polyolefin is sintered to the underbody in powdered form, no plasticisers or solvents (responsible for polluting emissions) are required. The polyolefin, having no chlorine, is much less polluting than PVC when disposed in recycling operations.

The polyolefin coating is very durable despite a relatively high MFI for a polyolefin and a relatively short stoving time and temperature, and therefore ideally suited for application in a production line process. The following examples illustrate the experience gained during experimentation where gravelometer tests indicate that a 300 μm polyolefin coating gives equivalent protection to a 800 μm layer of PVC coating. In addition, the density of the polyolefin is only 70% as dense as the PVC, so the polyolefin coating weighs a third of an equivalent PVC coating. 6-10 kg of PVC are usually used on a car underbody; a 2-4 kg reduction represents a significant saving in material.

### EXAMPLE 1

A coating powder was made by grinding an ethylene-acrylic acid copolymer into a powder and coating a mild steel plaque that had been coated with an automotive cathodic anticorrosion treatment. The ethylene-acrylic acid copolymer was Primacor 3460, a product of the Dow Chemical Company Ltd. The melt flow index of the mixture was 20 g/10 minutes, which gives an acceptably smooth surface finish. The plaques were coated to a thickness of 800 μm. In gravelometer testing according to the test SAE J400, no pinholes were recorded at 23° C. or −25° C.

The foregoing data demonstrate that at equivalent thickness to typical PVC coatings, polyolefins can give excellent protection to the substrate.

### EXAMPLE 2

In another test with a very much thinner coating, a melt blend of Engage® 8401, a non-polar ethylene α-olefin copolymer supplied by DuPont Dow Elastomers LLC, and Primacor 3440 in a 50:50 ratio was coated onto a metal plaque as described in the previous example, but at a thickness of only 100 μm. The melt flow index of the mixture was 20 g/10 minutes. Under gravelometer testing to SAE J400, 28 pinholes were recorded at 23° C. and 20 at −25° C., (equivalent to a rating of 5A and 6A respectively) but under gravelometer tests using chilled iron grit, Diamant GH-K angular, as manufactured by Eisenwerk Wurth GmbH, no pinholes were recorded.

### EXAMPLE 3

In a further test, a blend of Primacor 5980 (an ethylene-acrylic acid copolymer, a product of the Dow Chemical Company), Engage® 8401 (a non-polar ethylene α-olefin copolymer supplied by DuPont Dow Elastomers LLC), and Escor 5200 (an ethylene acrylic acid copolymer available from Exxon Chemicals Company), having an MFI of 38 g/10 minutes was cured at below 160° C. for less than 20 minutes, and produced results that equalled or exceed those of Examples 1 and 2 above.

The examples can all be characterised as having a smooth or reasonably smooth appearance. Smooth surfaces have better abrasion resistance compared to surfaces that can be characterised as having a rough or a wavy appearance. Smooth surfaces also coat a substrate more efficiently than a relatively rough surface, since the amount of material required to provide a minimum thickness necessary to offer protection against chippings and the like is larger for a rough surface than for a smooth one.

These data show that thin underbody coatings can give adequate stone-chip resistance, depending on the requirements of the vehicle manufacturer for the underbody area under test. Other polyolefins may be substituted in a straightforward fashion for the above polyolefins for use as underbody coatings.

As an alternative to applying the powder to a cold underbody, the underbody may be heated before or during application of the powder to facilitate easy removal of powder over-spray with subsequent heating of the underbody to ensure good adhesion of coating to metal substrate.

Rather than application with spray guns, the underbody could be dipped in a fluidised bed of the powder. Alternatively, the powder may be flame-sprayed onto the underbody.

1. A method of coating a least part of an underbody of a vehicle on a production line, comprising applying a polymeric coating powder to the underbody or the vehicle body part, and sintering the powder to the underbody or the vehicle body part, the polymeric coating powder including a mixture comprising a polyolefin having polar functionality, and one or more ethylene α-olefin copolymers, the mixture having a melt flow index greater than 15 g/10 minutes (2.16 kg, 190° C.).

2. A method according to claim 1, wherein the polymeric coating powder has a melt flow index greater than 20 g/10 minutes.

3. A method according to either claim 1 or claim 2 wherein the ethylene α-olefin copolymer contains at least 50 mole % ethylene.

4. A method according to any previous claim wherein the α-olefin co-monomer is chosen from the group containing propylene, butene, hexene or octene.

5. A method according to any previous claim wherein the polymer having polar functionality is a copolymer of ethylene with at least one polar monomer.

6. A method according to any previous claim wherein the polar monomer is acrylic acid, methacrylic acid, butyl acrylate, ethyl acrylate, methyl acrylate or vinyl acetate.

7. A method according to any previous claim wherein the polar copolymers are taken from the groups containing copolymers or terpolymers of ethylene or other alpha olefins with acrylic acid, methacrylic acid, butyl acrylate, ethylene acrylate, methylene acrylate, vinyl acetate, vinyl styrene, or other alkyl acrylates or methacrylates, or alkyl carboxylic acids.

8. A method according to any previous claim wherein one or more of the polymers having polar functionality is a grafted polyolefin.

9. A method according to claim 8, characterised in that the grafted polyolefin is modified by silane, maleic-anhydride, succinic-anhydride functional groups, or copolymers of ethylene and polar α-olefins, including acrylic acid, ethyl acrylate, vinyl acetate, vinyl styrene, or ionomers.

10. A method according to any previous claim wherein the coating powder includes an interpolymer of ethylene and styrene.

11. A method according to any previous claim wherein the coating powder includes a thermoplastic epoxy polymer.

12. A method according to any previous claim wherein the powder is applied by spray means.

13. A method according to any previous claim wherein the powder is at a different electrostatic potential to the underbody or the vehicle body part such that the powder is attracted to the underbody or the vehicle body part.

14. A method according to any previous claim wherein the underbody or the vehicle body part is heated to above the melting point of the powder immediately before, during or after the application of the powder.

15. A vehicle underbody as coated according to any previous claim.

16. A vehicle body as coated according to any previous claim.

17. A method substantially as herein described.

18. A vehicle underbody substantially as herein described.

19. A vehicle body part substantially as herein described.

20. A coating powder substantially as herein described.

21. Any novel and inventive feature or combination of features specifically disclosed herein within the meaning of Article 4H of the International Convention (Paris Convention).
